(19) United States
(12) Patent Application Publication
(10) Pub. No.: US 2006/0040554 A1
(43) Pub. Date: Feb. 23, 2006

(54) Electrical connector assembly

(75) Inventor: Yau-Hsuan Liu, Taipei (TW)

Correspondence Address: ZAGORIN O'BRIEN GRAHAM LLP, 7600B N. CAPITAL OF TEXAS HWY., SUITE 350, AUSTIN, TX, 78731, US

(73) Assignee: WAQO Technology Co., Ltd.

(21) Appl. No.: 11/055,294

(22) Filed: Feb. 10, 2005

(30) Foreign Application Priority Data
Aug. 18, 2004 (TW) 093124800

(51) Int. Cl. H01R 13/648

(52) U.S. Cl. 439/607

(57) ABSTRACT

A terminal module for an electrical connector includes a unitary metal frame having a plurality of terminal grooves, a plurality of insulative liners lining the respective terminal grooves, and a plurality of terminals respectively provided within the insulative liners. Preferably, an insulative body which includes the insulative liners is molded over the metal frame. In a preferred embodiment, the metal frame further includes a plurality of grounding elements which are exposed from the insulative body to interpose the terminals.

### CROSS-REFERENCE TO RELATED APPLICATION

This application claims priority of Taiwanese Application No. 093124800, filed on Aug. 18, 2004.

### BACKGROUND OF THE INVENTION

1. Field of the Invention

The present invention relates to an electrical connector assembly. More particularly, the present invention relates to an electrical connector assembly that can enhance data transmission rates and data transmission reliability, and obtain a good electromagnetic interference shielding effect to thereby effectively minimize crosstalk.

2. Description of the Related Art

Cable and connector assemblies used for computers (e.g., for connecting a peripheral device to a computer) are made utilizing various configurations in an effort to enhance their ability to transfer data at higher rates and more reliably. An example of such a configuration is the balanced-transmission cable-and-connector unit proposed in U.S. Pat. No. 6,336,827.

As shown in FIGS. 1 and 2, in a balanced-transmission cable-and-connector unit 1 of the above-referenced patent, leads 121 of wires 120 of a cable 12 are connected to signal and ground contacts 111, 112 of a connector 11 through connection pads of a junction substrate 13 of the connector 11. A metal shielding cover 14 is mounted covering the junction substrate 13 and all the elements connected thereto, and a front end of the shielding cover 14 is inserted into an insulative housing 15.

A drawback of the above configuration, however, is that data transmission rates are reduced as a result of such indirect interconnection between the cable 12 and the signal and ground contacts 111, 112 through the connection pads of the junction substrate 13. Furthermore, since the data have to travel through an extra element (i.e., the junction substrate 13), there is a heightened possibility that the data will become corrupted. Hence, the overall reliability of data transmission is reduced.

In addition, the exposed leads 121 of the wires 120 lie adjacent to one another on the junction substrate 13 with no electromagnetic shielding therebetween. Therefore, crosstalk and noise problems may occur between the leads 121 as a result of electromagnetic interference occurring between the leads 121. The quality of data transmission is diminished as a result.

FIG. 3 is a schematic view taken along a plane (X-Z plane) that is substantially normal to an axial direction of the cable 12. Although the signal contacts 111 adjacent to one another along the X-direction are separated from each other by the ground contacts 112, there is not full isolation between these elements in this direction as a result of the gaps between the ground contacts 112 and the shielding cover 14. Hence, there may occur crosstalk between the signals transmitted through the signal contacts 111 because of the lack of electromagnetic isolation therebetween.

### SUMMARY OF THE INVENTION

An object of this invention is to provide an electrical connector assembly with an improved terminal module to provide efficient electromagnetic shielding for terminals.

Another object of this invention is to provide an electrical connector assembly that can enhance the reliability of data transmission.

Yet another object of this invention is to provide an electrical connector assembly that provides effective shielding from electromagnetic interference to thereby improve the quality of data transmission.

According to one aspect of the present invention, an electrical connector comprises a unitary metal frame including a plurality of terminal grooves, an insulative body molded over the metal frame and having a plurality of insulative liners respectively lining the terminal passages, and a plurality of terminals respectively disposed within the insulative liners. The metal frame further includes a plurality of grounding elements exposed from the insulative body and extending substantially in the same direction as the terminal grooves.

According to another aspect of the present invention, a terminal module comprises a unitary metal frame having a plurality of terminal grooves, a plurality of insulative liners disposed respectively in the terminal grooves, and a plurality of terminals disposed within the insulative liners, respectively.

### BRIEF DESCRIPTION OF THE DRAWINGS

Other features and advantages of the present invention will become apparent in the following detailed description of the preferred embodiment with reference to the accompanying drawings, of which:

FIG. 1 is a partly disassembled perspective view of a conventional signal line transmission cable and connector unit;

FIG. 2 is a sectional view of the conventional signal line transmission cable and connector unit of FIG. 1;

FIG. 3 shows an arrangement of signal and ground contacts of the connector unit of FIG. 1;

FIG. 4 is a perspective view of an electrical connector assembly according to a preferred embodiment of the present invention;

FIG. 5 is an exploded perspective view of the preferred embodiment;

FIG. 6 is a partly sectional, schematic side view of the preferred embodiment;

FIG. 7 is a perspective view illustrating a metal frame of the preferred embodiment;

FIG. 8 is a perspective view illustrating a terminal module of the preferred embodiment;

FIG. 9 is a perspective view illustrating the terminal seat and terminals mounted thereon of the preferred embodiment;

FIG. 10 is a sectional view taken along line 10-10 of FIG. 8;

FIG. 11 is a sectional view similar to FIG. 10, but with the terminals, signal lines, and a metal shield mounted on the terminal module;

FIG. 12 is a sectional view illustrating an alternative structure of terminal module;

FIG. 13 is the same view as FIG. 9 but with the terminal module being rotated by 180 degrees;

FIG. 14 is a sectional view taken along line 14-14 of FIG. 13;

FIG. 15 is a sectional view showing an alternative insulative liner for the terminal module;

FIG. 16 is a perspective view of a metal frame for another preferred embodiment of the terminal module according to the present invention;

FIG. 17 is a perspective view of the terminal module of FIG. 16;

FIG. 18 is an elevation view of the terminal module of FIG. 16;

FIG. 19 is the same view as FIG. 17 but with terminals inserted therein;

FIG. 20 is a perspective view of a metal frame for still another preferred embodiment of the terminal module according to the present invention;

FIG. 21 is a perspective view of the terminal module of FIG. 20;

FIG. 22 is an elevation view of the terminal module of FIG. 21; and

FIG. 23 is the same view as FIG. 21 but with terminals inserted therein.

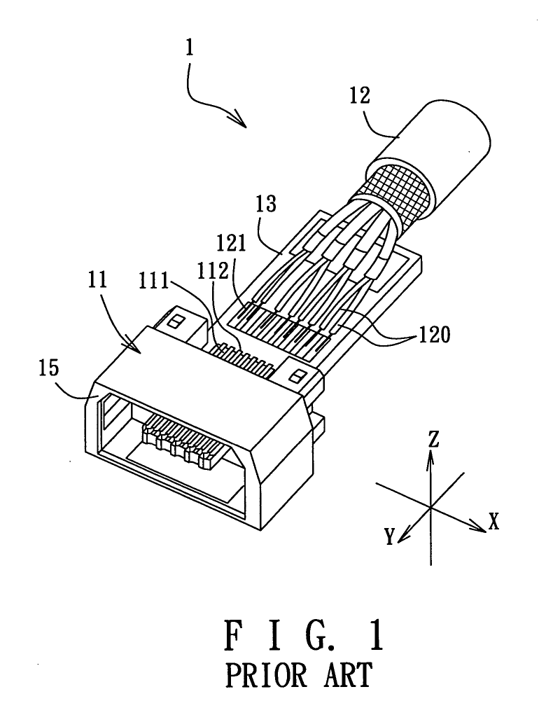

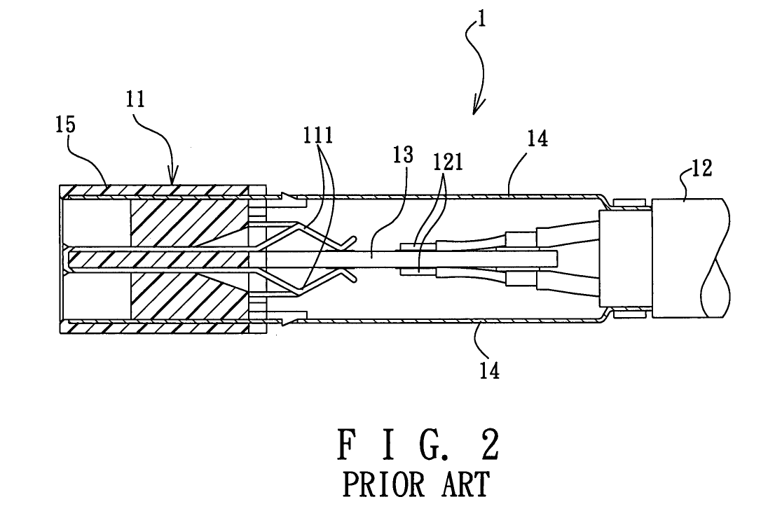

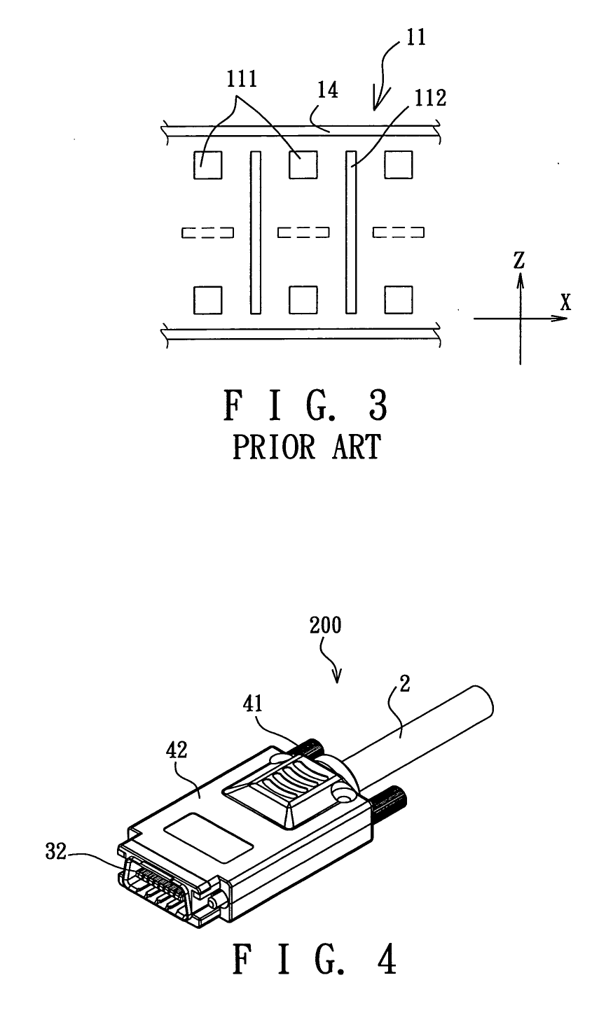

### DETAILED DESCRIPTION OF THE PREFERRED EMBODIMENTS

Referring to FIGS. 4, 5, and 6, an electrical connector assembly 200 according to a preferred embodiment of the present invention includes a cable 2 and an electrical connector 3 electrically coupled to the cable 2.

The cable 2 includes a plurality of signal lines 211, 211′, and a plurality of ground lines 212. As an example of a configuration that may be employed, the signal lines 211, 211′ and the ground lines 212 are grouped together in an assembly of three of the same (i.e., groups of one of the signal lines 211, one of the signal lines 211′, and one of the ground lines 212), and each such grouping is bundled together by an insulating sheath 22. Ends of the signal lines 211, 211 and the ground lines 212 are left exposed, that is, uncovered by the insulating sheaths 22. The insulating sheaths 22 are made of an insulative material, such as plastic.

The cable 2 further includes a sleeve 23 covering the assembly of the signal lines 211, 211′, the ground lines 212, and the insulating sheaths 22 starting at a predetermined distance from the exposed ends of the signal lines 211, 211′ and the ground lines 212, and extending to the other end of the cable 2. The cable 2 may also include an alignment member 25 that arranges the insulating sheaths 22 so that they are substantially aligned along one direction.

A pair of holders 24 may be provided to clamp the end of the cable 2 adjacent to the sleeve 23 or the alignment member 25. A plurality of grooves 241 are formed in each of the holders 24, and each of the insulating sheaths 22 is positioned within a corresponding one of the grooves 241.

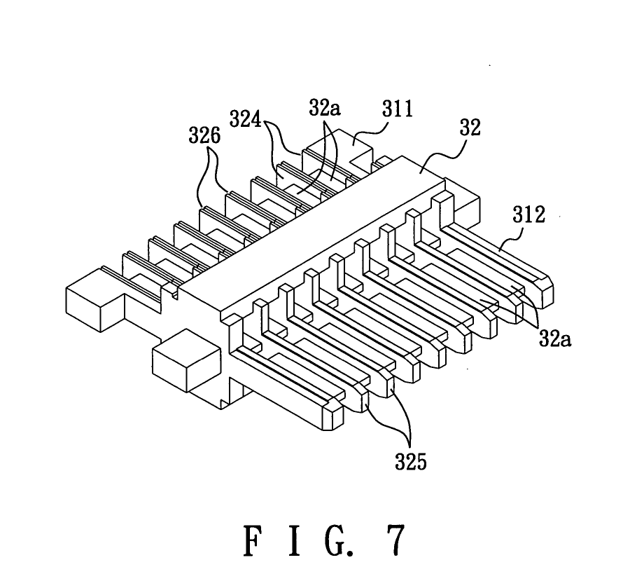

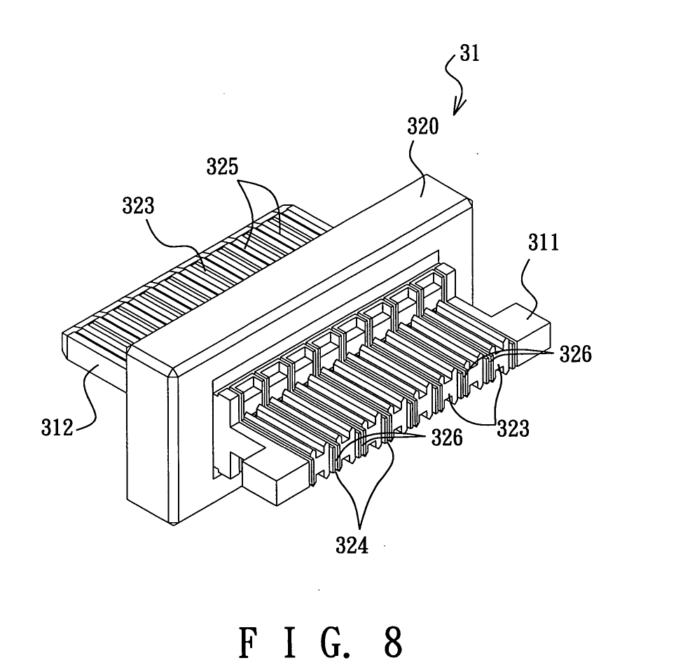

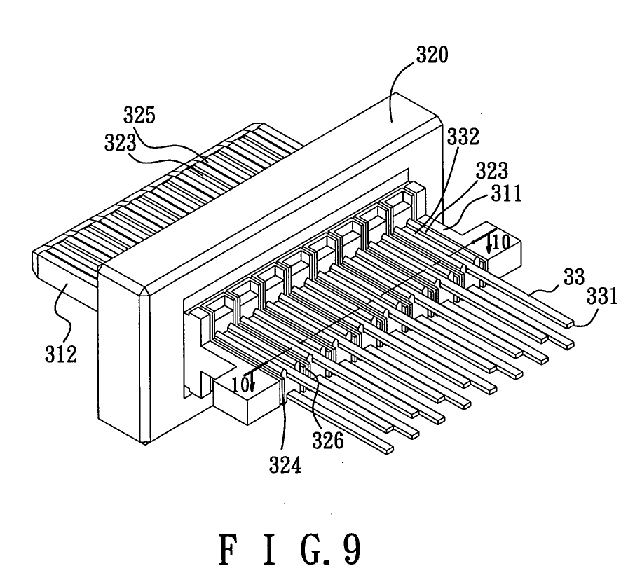

Referring to FIGS. 7-10, in combination with FIGS. 4-6, the electrical connector 3 includes a terminal module 31 having a plurality of terminals 33, and a metal shield 34 surrounding the terminal module 31.

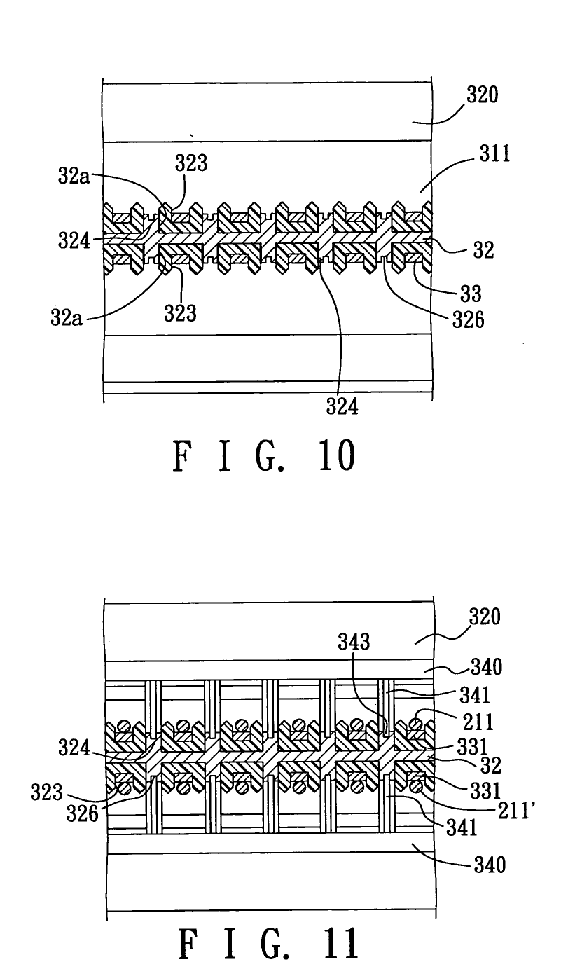

The terminal module 31 includes a unitary metal frame 32 which has a plurality of terminal grooves 32a. An insulative body 320 is molded over the metal frame 32, and includes a plurality of insulative liners 323 respectively lining the terminal grooves 32a (FIG. 10). In this embodiment, the metal frame 32 has first and second portions 311, 312, and the terminal grooves 32a extend from the first portion 311 to the second portion 312.

The metal frame 32 further includes a plurality of grounding elements 324, 325 that extend substantially in the same direction as the terminal grooves 32a and interpose the terminal grooves 32a. That is, one of the terminal grooves 32a is disposed between two of the grounding elements 324, 325. The grounding elements include first grounding partitions 324 which are exposed from the insulative body 320 in the first portion 311, and ground contacts 325 which are exposed from the insulative body 320 in the second portion 312. Since the first grounding partitions 324 and the ground contacts 325 are formed from the metal frame 32, they are interconnected integrally and electrically.

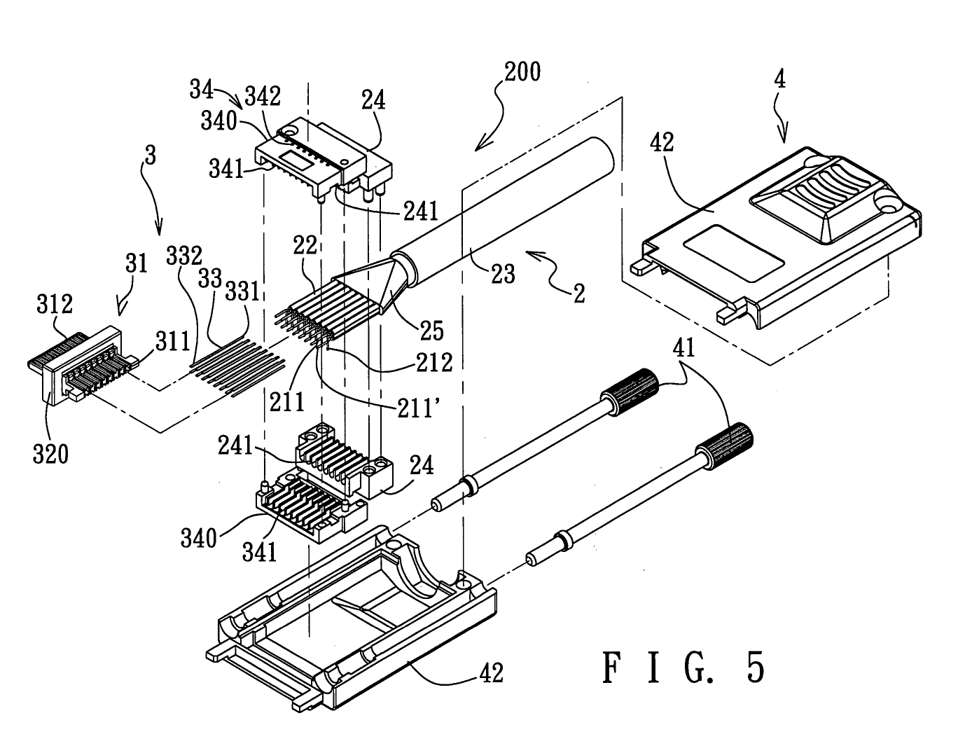

Each of the terminals 33 includes a soldering section 331 and a contact section 332 as best shown in FIG. 5. The soldering sections 331 of the terminals 33 are respectively positioned in the insulative liners 323 of the terminal grooves 32a extending in the first portion 311 of the metal frame 32. The contact sections 332 of the terminals 33 are respectively positioned in the insulative liners 323 of the terminal grooves 32a extending in the second portion 312 of the metal frame 32. Therefore, the first grounding partitions 324 interpose the soldering sections 331 of the terminals 33, and the ground contacts 325 interpose the contact sections 332 of the terminals 33.

The metal shield 34 surrounds the first portion 311 of the metal frame 32, and includes a plurality of second grounding partitions 341 which project from the metal shield 34 toward the first grounding partitions 324 of the metal frame 32. The second grounding partitions 341 overlap and connect with the first grounding partitions 324. As best shown in FIGS. 7 and 11, each of the first grounding partitions 324 has a longitudinal edge formed with a longitudinal flute 326, and each of the second grounding partitions 341 has a longitudinal edge 343 fitted in the longitudinal flute 326 of a corresponding one of the first grounding partitions 324. Hence, the metal shield 34 cooperates with the first grounding partitions 324 to provide electromagnetic isolation between the terminals 33.

Each of the first and second portions 311, 312 of the metal frame 32 has a top side and a bottom side, and the terminal grooves 32a are preferably formed at both of the top and bottom sides of the first portion 311 as shown in FIG. 10, as well as of the second portion 312 as shown in FIG. 14. With this structure, with reference to FIG. 11, the signal lines 211 are respectively positioned in the insulative liners 323 of the top side of the first portion 311 with the soldering sections 331 of the terminals 33 interposed therebetween, and the signal lines 211′ are respectively positioned in the insulative liners 323 of the bottom side of the first portion 311 with the soldering sections 331 of the terminal 33 interposed therebetween. As an example, the signal lines 211 carry a transmit signal, while the signal lines 211′ carry a receive signal. With reference to FIG. 11, the exposed ends of the signal lines 211, 211′ are fully isolated from each other through this structure such that electromagnetic interference does not occur therebetween.

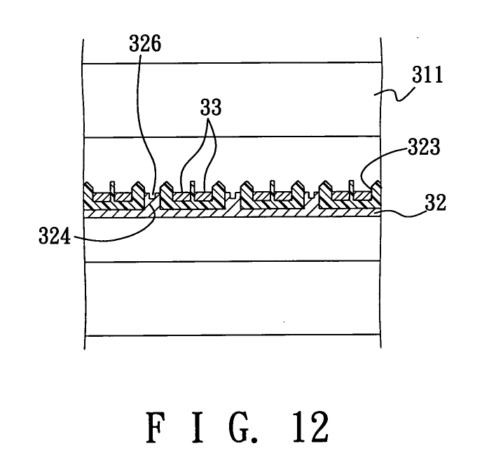

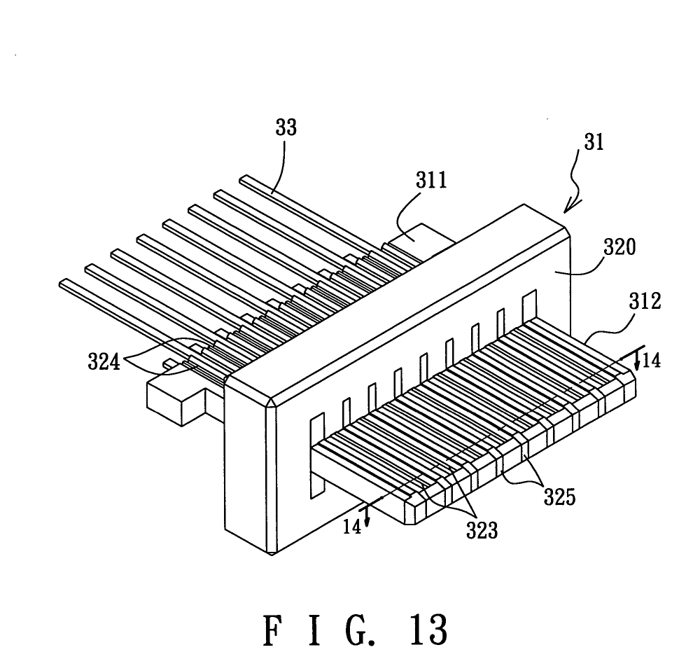

In an alternative configuration, with reference to FIG. 12, a pair of terminals 33 are disposed between two of the grounding elements 324, 325, and the terminal 33 are provided only on the top side of the first and second portions 311, 312 (only the first grounding partitions 324 in the first portion 311 are shown). With this configuration, one of the signals lines 211 and one of the signal lines 211′ may be positioned in each of the terminal grooves 323 between each pair of the first grounding partitions 324.

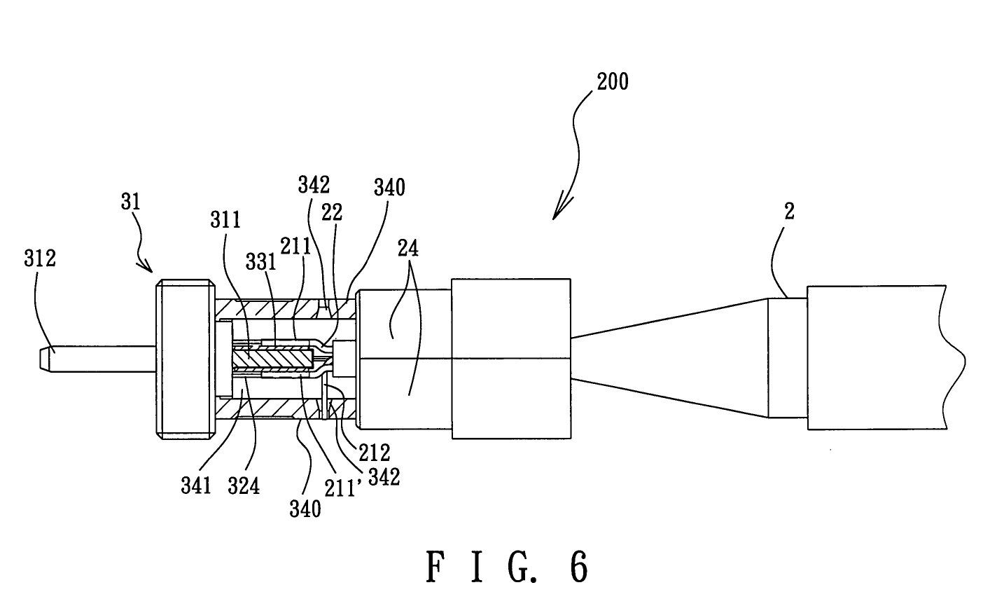

The metal shield 34 may be formed including two halves 340 that respectively cover the top and bottom sides of the first portion 311. Each of the halves 340 of the metal shield 34 includes engaging holes 342 as best shown in FIG. 5, and the engaging holes 342 of each of the two halves 340 of the metal shield 34 respectively engage the ground lines 212 as best shown in FIG. 6. Alternatively, the ground lines 212 may be soldered to the metal shield 34 while positioned in the engaging holes 342, but soldering need not necessarily be performed. In either case, the ground lines 212 are electrically connected to the metal shield 34.

The ground contacts 325 of the terminal seat 31 are adapted to mate with ground contacts of a complementary connector (not shown), which, in turn, is electrically connected to a printed circuit board (not shown). Therefore, the ground contacts 325 can be grounded through grounding pads formed on the printed circuit board. Ultimately, since the grounding partitions 341 are respectively fitted in the longitudinal flutes 326, and since the first grounding partitions 324 and the ground contacts 325 are integrally formed, the ground lines 212 are grounded through the ground contacts 325. Other methods may also be employed to ground the cable 2, such as utilizing a conventional metal braid structure (not shown) positioned to the outside of the insulating sheaths 22.

Referring again to FIG. 5, the electrical connector assembly 200 may further include a metal casing 4 that surrounds the electrical connector 3 and the holder 24, as well as parts of the cable 2 connected to and encased by the electrical connector 3 and the holder 24. The metal casing 4 includes a pair of case units 42 that oppose one another with the electrical connector 3 and the holder 24 interposed between the case units 42. Locking pins 41 pass through and between the case units 42 along opposite sides thereof and substantially in the axial direction of the cable 2. The locking pins 41 are operable to secure the metal casing 4 to an electronic device (not shown) in a known manner.

In the electrical connector assembly 200 described above, as a result of the direct soldering connection of the terminals 33 with the signal lines 211, 211′ of the cable 2, faster data transmission rates are realized compared to the indirect connection between the connector contacts 111, 112 and the cable leads 121 through the junction substrate 13 as disclosed in U.S. Pat. No. 6,336,827. Furthermore, the signal lines 211, 211′ are completely isolated from each other by the first and second grounding partitions 324, 341 such that no electromagnetic interference occurs therebetween. In addition, the provision of the metal frame 32 simplifies integration of the first and second grounding partitions 324, 341 with the terminals 33. The use of the metal casing 4, in addition, shields the signal elements therein from external electromagnetic interference.

It is noted that a primary feature of the present invention resides in the use of the terminal module 31. The unitary metal frame 32 of the terminal module 31 which is formed with the terminal grooves 32a constitutes a unique structure which can provide effective magnetic shielding for the terminals 33. Since the terminal grooves 32a are lined with the insulative liners 323, no short circuiting will occur between the terminals 33.

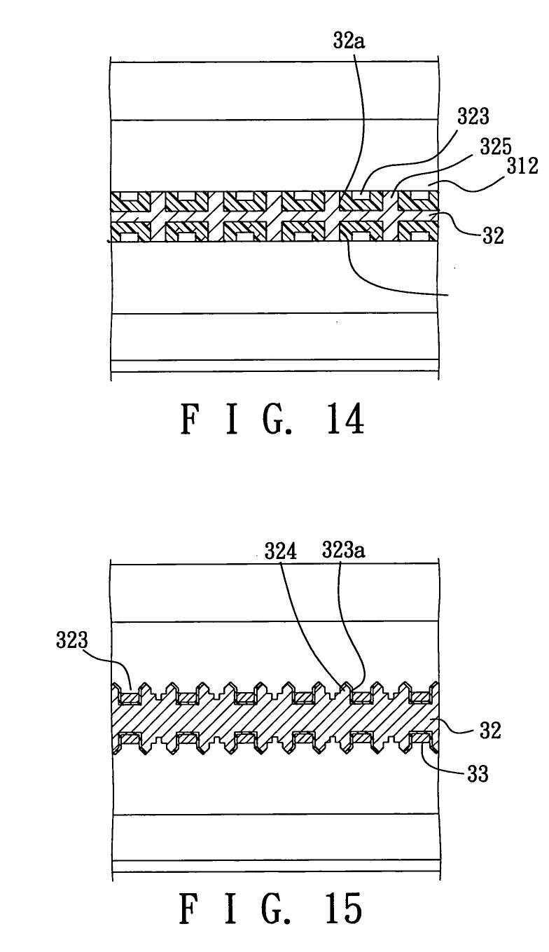

The terminal module 31 may be fabricated by performing injection molding of the insulative body 320 over the metal frame 32 which is preformed with the terminal grooves 32a. The insulative liners 323 may be formed integrally with the insulative body 320 during injection molding. Alternatively, it is possible to use insulative coating layers 323a shown in FIG. 15 in place of the insulative liners 323.

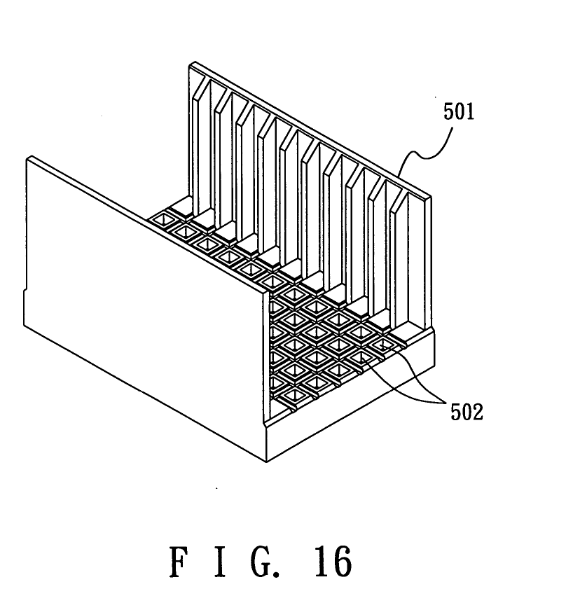

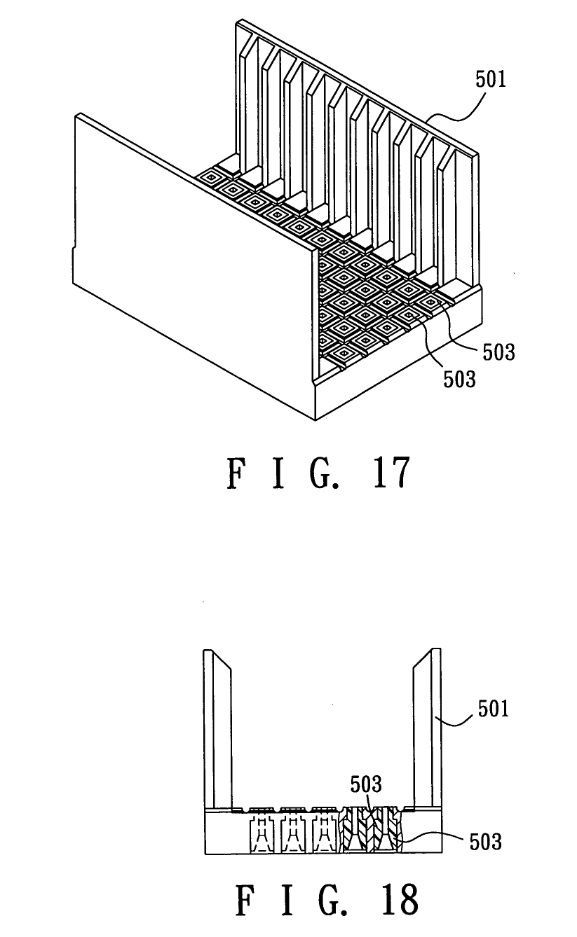

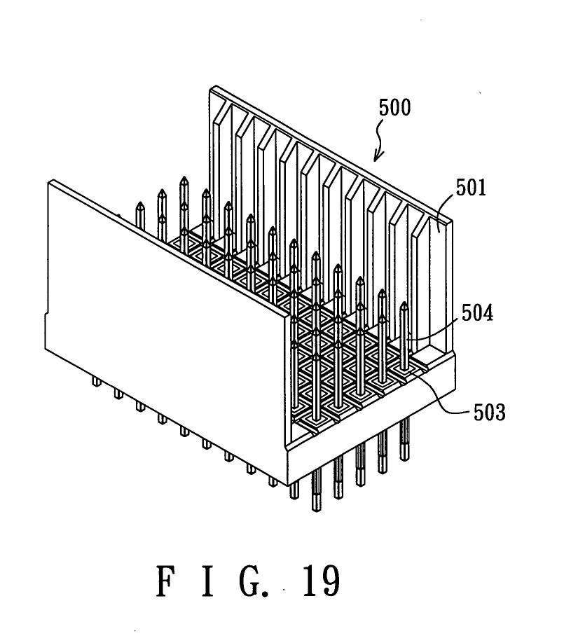

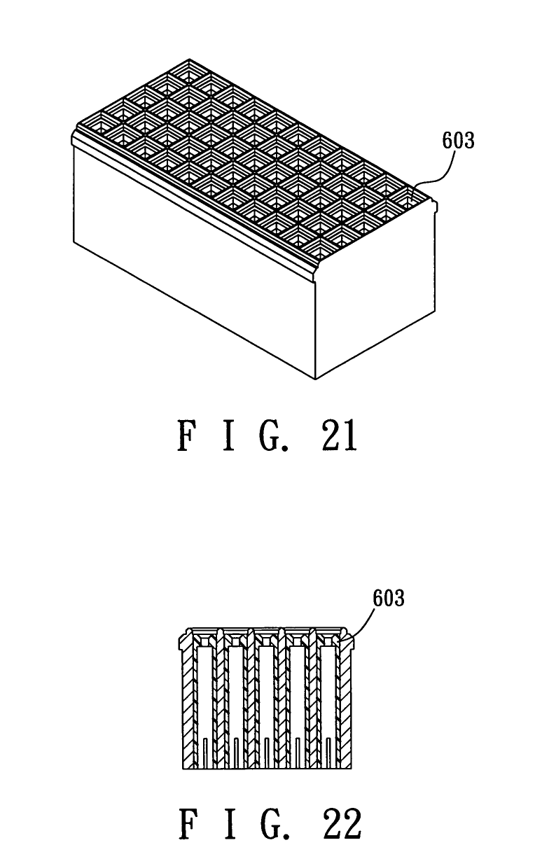

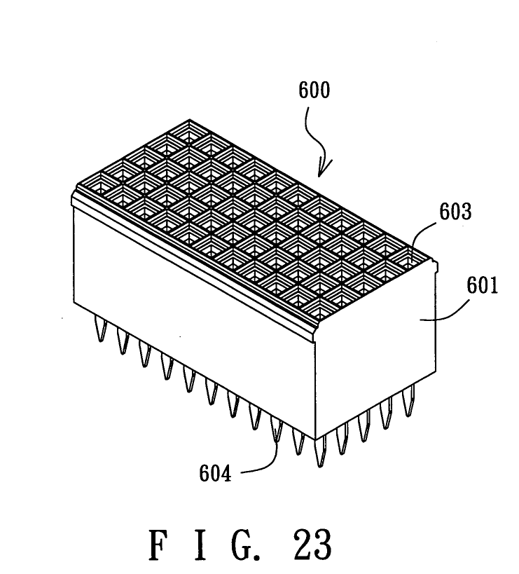

While the terminal module according to the present invention has been described in terms of the cable connector 200, the application of the present invention is not limited only thereto. The present invention is also applicable to other types of connectors which include a plurality of terminals for signal transmission. Examples of such connectors are shown in FIGS. 16 to 23. FIGS. 16 to 19 show a terminal module 500 of a plug connector for connection with a circuit board. The plug connector includes a metal frame 501 with a plurality of terminal grooves 502, each of which is lined with an insulative liner 503. A plurality of terminals 504 are inserted into the respective insulative liners 503.

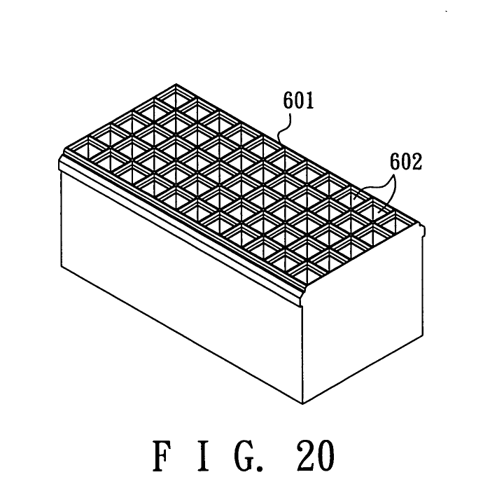

FIGS. 20 to 23 show a terminal module 600 of a socket connector for connection with a circuit board. The terminal module 600 includes a metal frame 601 with a plurality of terminal grooves 602, each of which is lined with an insulative liner 603. A plurality of terminals 604 are inserted into the respective insulative liners 603.

The metal frames 501 and 601 may be fabricated through any forming process using suitable metallic materials. For example, the fabrication of the metal frames 501 and 601 may be conducted through a casting process using an alloy, such as an aluminum-magnesium alloy or aluminum-zinc alloy. A powder metallurgy technology may also be used to produce the metal frames 501 and 601 by using a suitable metal powder such as copper.

The insulative liners 503, 603 may be formed as individual pieces which can be inserted into the respective terminal grooves 502, 602. Alternatively, the insulative liners 503, 603 may be formed integrally by injection molding. In this case, the insulative liners 503, 603 will be connected to an insulative body which is molded over the metal frame 501 or 601.

In both of the plug and socket connectors 500, 600, as the metal frames 501, 601 are unitary bodies, each terminal groove 502, 602 is confined by a metal wall which surrounds the corresponding terminal 504, 604 without producing any discontinuation or gap therein. As a result, effective electromagnetic shielding is provided for the terminals 504, 604. In addition, the unitary structure of the metal frames 501, 601 may be constructed conveniently without the need to employ complicated assembly steps.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An electrical connector comprising:
a unitary metal frame including a plurality of terminal grooves;
an insulative body molded over said metal frame and having a plurality of insulative liners respectively lining said terminal passages; and
a plurality of terminals respectively disposed within said insulative liners,
said metal frame further having a plurality of grounding elements exposed from said insulative body, said grounding elements extending substantially in the same direction as said terminal grooves.

2. The electrical connector as claimed in claim 1, wherein at least one of said terminal grooves is disposed between two of said grounding elements.

3. The electrical connector as claimed in claim 1, wherein said metal frame includes first and second portions, each of said terminal grooves extending from said first to said second portions, each of said terminals including a soldering section extending in said first portion, and a contact section extending in said second portion.

4. The electrical connector as claimed in claim 3, wherein said grounding elements are formed as first grounding partitions that interpose said soldering sections of said terminals.

5. The electrical connector as claimed in claim 4, wherein said grounding elements are formed as ground contacts that interpose said contact sections of said terminals.

6. The electrical connector as claimed in claim 1, further comprising a metal shield surrounding said first portion of said metal body, and including a plurality of second grounding partitions which project from said metal shield toward said first grounding partitions, respectively, said second grounding partitions respectively overlapping and connecting with said first grounding partitions.

7. The electrical connector as claimed in claim 6, wherein each of said first grounding partitions has a longitudinal edge formed with a longitudinal flute, each of said second grounding partitions having a longitudinal edge fitted in said longitudinal flute of a corresponding one of said first grounding partitions.

8. The electrical connector as claimed in claim 7, wherein said grounding elements further include a plurality of ground contacts that interpose said contact sections of said terminals, said first grounding partitions and said ground contacts being interconnected integrally.

9. A terminal module comprising:
a unitary metal frame having a plurality of terminal grooves;
a plurality of insulative liners disposed respectively in said terminal grooves; and
a plurality of terminals disposed within said insulative liners, respectively.

10. The terminal module as claimed in claim 9, further comprising an insulative body injection molded over said metal frame, said insulative liners being integrally formed with said insulative body.

11. A method of making a terminal module comprising:
(a) forming a unitary metal frame having a plurality of terminal grooves;
(b) providing each of said terminal grooves with an insulative liner; and
(c) disposing a terminal within said insulative liner.

12. The method as claimed in claim 11, wherein the step (b) includes injection molding an insulative body over said metal frame, said insulative body including a plurality of said insulative liners extending respectively into said terminal grooves.
